(19) United States
(12) Patent Application Publication
(10) Pub. No.: US 2007/0149901 A1
(43) Pub. Date: Jun. 28, 2007

(54) Methods and apparatus for pulsed electromagnetic therapy

(75) Inventors: Glen Gordon, Port Gamble, WA (US); Donald Haueisen, Olalla, WA (US); Robert Brunton, Greenbank, WA (US)

Correspondence Address: KLARQUIST SPARKMAN, LLP, 121 SW SALMON STREET, SUITE 1600, PORTLAND, OR, 97204, US

(73) Assignee: EM-Probe, Inc.

(21) Appl. No.: 11/636,018

(22) Filed: Dec. 8, 2006

Related U.S. Application Data
(60) Provisional application No. 60/748,960, filed on Dec. 8, 2005.
(60) Provisional application No. 60/835,031, filed on Aug. 1, 2006.

(51) Int. Cl. A61H 1/00; A61H 1/02

(52) U.S. Cl. 601/15; 601/48

(57) ABSTRACT

Exemplary embodiments of pulsed electromagnetic therapy systems, methods, and devices are disclosed. For example, in one exemplary embodiment, an electromagnetic therapy system is disclosed that comprises a pulse-generating circuit configured to create current pulses having rise or fall times of less than 100 nanoseconds. The system further comprises two or more flexible activation elements coupled to the pulse-generating circuit and extending outwardly from and returning to the pulse-generating circuit. The activation elements are configured to conduct the current pulses and thereby generate time-varying magnetic fields. The system further comprises a flexible outer housing that encloses both the pulse-generating circuit and the activation elements. The housing is further configured to define an exterior surface that is conformable to a region of a subject to be treated and that thereby positions the activation elements adjacent to the region of the subject to be treated.

### RELATED APPLICATION INFORMATION

This application claims the benefit of U.S. Provisional Patent Application Nos. 60/748,960, filed Dec. 8, 2005, and 60/835,031, filed Aug. 1, 2006, both of which are hereby incorporated herein by reference.

### FIELD

This application relates generally to devices for generating pulsed electromagnetic fields, such as can be used for treating tissue injuries in humans or animals.

### BACKGROUND

The therapeutic value of pulsed electromagnetic fields has been recognized in numerous studies and observed in many clinical applications. Magnetic fields are known to penetrate deeply into human tissue with little attenuation, and have been observed to promote, for example, both bone and tissue regeneration.

A number of systems and devices have been developed to apply the observed benefits of pulsed electromagnetic fields in a therapeutic environment. These devices, however, typically generate high-strength magnetic fields (for example, on the order of 4-5 gauss) and sine-wave pulses with comparatively long rise and fall times (for example, on the order of microseconds). It has been observed, however, that shorter rise or fall times can promote faster healing and tissue regeneration. This beneficial result is understood to be related to the broad harmonic spectrum of frequencies generated in the frequency domain by the fast rise or fall times of the current pulse.

Furthermore, as a group, conventional electromagnetic therapy devices are heavy (for example, several hundred pounds) stationary devices which often surround an entire limb or body of the patient. In at least some instances, the size of these devices is driven by the magnetic coil technology that is used to produce the exceedingly strong magnetic fields. On account of their size and cost, such devices are unsuitable for many therapeutic applications, let alone individual use.

Accordingly, there exists a need for alternative devices for pulsed electromagnetic field therapy that generate current pulses having faster rise or fall times and that are more appropriate for therapeutic and individual use.

### SUMMARY

Disclosed herein are exemplary electromagnetic therapy systems, methods, and devices. In one exemplary embodiment, an electromagnetic therapy system is disclosed that comprises a pulse-generating circuit configured to create current pulses having rise or fall times of less than 100 nanoseconds. The system further comprises two or more flexible activation elements coupled to the pulse-generating circuit and extending outwardly from and returning to the pulse-generating circuit. The activation elements are configured to conduct the current pulses and thereby generate time-varying magnetic fields. The system further comprises a flexible outer housing that encloses both the pulse-generating circuit and the activation elements. The housing is further configured to define an exterior surface that is conformable to a region of a subject to be treated and that thereby positions the activation elements adjacent to the region of the subject to be treated. The housing can be a pad-shaped housing and can have a width that is less than the height and the length of the housing. The activation elements can form single loops extending from the pulse-generating circuit. The pulse-generating circuit can further comprise timing circuitry configured to provide the current pulses to subsets of the activation elements according to a predetermined sequence, the subsets each comprising at least one of the activation elements. Furthermore, the timing circuitry can be further configured to provide current pulses to the subsets of the activation elements such that adjacent activation elements are not pulsed concurrently. The activation elements can be implemented as waveguide structures defined on a substrate (for example, striplines defined on a substrate). The activation elements can also be stranded wires. In certain exemplary implementations, the pulse-generating circuit is configured to create current pulses having rise times of less than 20 nanoseconds and/or current pulses that generate magnetic fields of less than 3 gauss. The pulse-generating circuit can also comprise a timer for generating a current-pulse waveform, and one or more transistors coupled to the timer and configured to produce the current pulses delivered to the activation elements from the current-pulse waveform. The pulse-generating circuit can also comprise one or more field generator sections, each field generator section corresponding to a respective subset of one or more of the activation elements and comprising transistors that generate the current pulses provided to the respective one or more activation elements in the subset. In certain exemplary implementations, the pulse-generating circuit can further comprise one or more capacitors used in generating the current pulses, the one or more capacitors being shared between at least two of the field generator sections.

In another exemplary embodiment, an electromagnetic therapy system is disclosed comprising a flexible housing defining an internal compartment and an exterior surface that is conformable to a body part of a subject. In this embodiment, the flexible housing has a height, a length, and a width, the width being less than the height and the length (for example, at least 3-10 times less than the height and the length). For example, in certain exemplary implementations, the width is less than 3 inches. The system can further comprise a circuit housed within the internal compartment of the flexible housing, the circuit including a plurality of conductive elements disposed across at least a majority of the interior compartment. The circuit and the conductive elements can be configured to generate time-varying magnetic fields that extend out of the exterior surface of the flexible housing when the circuit is activated. The conductive elements can comprise U-shaped elements extending from the circuit and/or form singular loops extending from the circuit. In certain exemplary implementations, the circuit generates current pulses having rise or fall times less than 100 nanoseconds (for example, less than 20 nanoseconds). The plurality of conductive elements can include striplines defined on a flexible substrate and/or stranded wires.

In another exemplary embodiment, an electromagnetic therapy system is disclosed comprising a flexible housing defining an interior. The system further comprises a pulse-generating circuit located at least partially within the interior of the flexible housing. The system further comprises two or more conductive elements forming single loops operatively coupled to the pulse-generating circuit and located within the interior of the flexible housing. In this embodiment, the pulse-generating circuit includes timing circuitry configured to generate current pulses in subsets of the conductive elements according to a sequence, the subsets of the conductive elements respectively comprising one or more of the conductive elements. The timing circuitry can be configured such that current pulses are not generated concurrently in adjacent conductive elements. The two or more conductive elements can extend across a majority of the interior of the housing. A common set of one or more capacitors can be used when the current pulses in the subsets of the conductive elements are activated. The pulse-generating circuit can be configured to produce current pulses of 100 nanoseconds or less in the conductive elements. The flexible housing can be a pad-shaped housing with a height dimension, a length dimension, and a width dimension, the width dimension being less than the height dimension and the length dimension by a factor of at least 3 to 10. In certain exemplary implementations, the flexible housing has a width that is less than 3 inches.

Exemplary methods for performing electromagnetic therapy are also disclosed herein. For example, in one exemplary embodiment, a conformable surface of an electromagnetic therapy system is placed adjacent to a region of the subject that is to be treated. The electromagnetic therapy system is operated such that current pulses having rise or fall times of less than 100 nanoseconds are sequentially provided to multiple activation elements disposed in the electromagnetic therapy system and positioned in proximity to the conformable surface. The multiple activation elements extend from a pulse-generating circuit in the electromagnetic therapy system. Various conditions and/or injuries can be identified in a subject and treated in this manner (for example, tissue trauma, inflammation resulting from tissue trauma, free-radical-mediated conditions, osteoporosis, osteopenia, ischemia-perfusion injuries, and the like).

The foregoing and other objects, features, and advantages of the disclosed technology will become more apparent from the following detailed description, which proceeds with reference to the following drawings.

### BRIEF DESCRIPTION OF THE DRAWINGS

FIG. 1 is a perspective view of the housing of an exemplary pulsed electromagnetic therapy system.

FIG. 2 is a perspective view of the exemplary system shown in FIG. 1 wherein the housing is enclosed within an external layer.

FIG. 3 is a top view of an exemplary pulse-generating circuit as can be enclosed within the housing of the exemplary electromagnetic therapy system shown in FIG. 1.

FIGS. 4A through 4I are schematic block diagrams illustrating various possible activation element configurations.

FIG. 5 is a circuit diagram of a first exemplary pulse-generating circuit as can be used as the pulse-generating circuit shown in FIG. 3.

FIGS. 6A and 6B are circuit diagrams of a second exemplary pulse-generating circuit as can be used as the pulse-generating circuit shown in FIG. 3.

FIG. 7 is a schematic top view of one particular example of a pulsed electromagnetic therapy system as in FIG. 1.

FIG. 8 is a schematic cross-sectional side view of the embodiment shown in FIG. 7.

FIG. 9 is a schematic perspective view of the embodiment shown in FIG. 7.

FIG. 10 is a schematic top view of one particular example of a pulsed electromagnetic therapy system using stripline resonators.

### DETAILED DESCRIPTION

As used in this description and the claims, the singular forms “a,” “an,” and “the” include the plural forms unless the context clearly dictates otherwise. The term “or” refers to a single element of stated alternative elements or a combination of two or more elements. For example, the phrase “rise or fall times” refers to rise times, fall times, or both rise times and fall times. Additionally, the term “includes” means “comprises.” Further, the term “coupled” means electrically or electromagnetically connected or linked and does not necessarily exclude the presence of intermediate circuit elements between the coupled items.

Disclosed below are representative embodiments of systems, methods, and apparatus that can be used to produce pulsed electromagnetic fields. For example, some of the disclosed embodiments can produce low-strength magnetic fields (for example, about 3 gauss or less) using current pulses that have fast rise or fall times (for example, about 100 nanoseconds or less). The rise times referred to herein correspond to the time it takes a referenced element to transition from 10% to 90% of its operative voltage when a current pulse is applied, wherein the operative voltage is a maximum voltage associated with the current pulse. Likewise, the fall times referred to herein correspond to the time it takes a signal on the referenced element to transition from 90% to 10% of its operative voltage when a current pulse is applied. In some instances, the current pulses also have short pulse widths (for example, around 1 microsecond or less, such as about 200 nanoseconds). As used herein, the term pulse width refers to the time a referenced element is at the operative voltage when a current pulse is applied (for example, the time between the rise and fall times). The current pulse can thus approximate square pulses in shape. Furthermore, in certain embodiments, the frequency of the current pulse is in the range of 10 to 100 hertz (for example, about 70 hertz). Further examples of the current pulses that can be produced by embodiments of the disclosed technology as well as other circuit configurations for producing such pulses that can be included in embodiments of the disclosed technology are described in U.S. Patent Application Publication No. 2004/0230224, which is incorporated herein by reference.

Also disclosed herein are exemplary methods by which the embodiments can operate or be operated. For example, embodiments of the disclosed technology can be used to treat injured, diseased, normal, or other tissues of human or animal subjects. For example, embodiments of the disclosed technology can be used to treat pain, tissue trauma, inflammation resulting from tissue trauma, lethal challenge conditions (caused, for example, from free radical events resulting from intermediate to serious trauma), and other such conditions (for example, other free-radical-mediated events). Embodiments of the disclosed technology can also be used to treat osteoporosis (for example, axial osteoporosis) and osteopenia. Embodiments of the disclosed technology can also be used to treat ischemia-reperfusion injuries (for example, stroke, heart attack, and trauma). Exemplary environments and applications for the disclosed embodiments are also disclosed.

The described systems, apparatus, and methods should not be construed as limiting in any way. Instead, the present disclosure is directed toward all novel and nonobvious features and aspects of the various disclosed embodiments, alone and in various combinations and sub-combinations with one another. The disclosed systems, methods, and apparatus are not limited to any specific aspect or feature or combination thereof, nor do the disclosed systems, methods, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

The disclosed circuits can be implemented using a wide variety of circuit fabrication technologies. For example, embodiments of the disclosed technology (or any component or portion thereof) can be implemented as application-specific integrated circuits (ASICs), systems-on-a-chip (SOCs), systems in a package (SIPs), systems on a package (SOPs), multi-chip modules (MCMs), components on a printed circuit board (PCB), or other such device. Furthermore, the various components of the disclosed embodiments can be implemented (separately or in various combinations and subcombinations with one another) using a variety of different semiconductor materials, including but not limited to: gallium arsenide (GaAs) and GaAs-based materials (AlGaAs, InGaAs, AlAs, InGaAlAs, InGaP, InGaNP, AlGaSb, and the like); indium phosphide (InP) and InP-based materials (InAlP, InGaP, InGaAs, InAIAs, InSb, InAs, and the like); silicon (Si), strained silicon, germanium (Ge) and silicon- and germanium-based materials (SiGe, SiGeC, SiC, SiO₂, high dielectric constant oxides, and the like) such as complementary metal-oxide-semiconductor (CMOS) processes; 9- and gallium nitride materials (GaN, AlGaN, InGaN, InAlGaN, SiC, Sapphire, Si, and the like). In certain embodiments, for example, the pulse-generating circuit is implemented on a PCB using circuit components implemented according to one or more of these process technologies. In other embodiments, the pulse-generating circuit can be implemented using multiple PCBs or chips.

Similarly, a variety of transistor technologies can be used to implement the disclosed embodiments. For example, the disclosed circuit embodiments can be implemented using bipolar junction transistor (BJT) technologies (for example, heterojunction bipolar junction transistors (HBTs)) or field effect transistor (FET) technologies (for example, pseudomorphic high electron mobility transistors (pHEMTs)). Combinations or subcombinations of these technologies or other transistor technologies can also be used to implement the disclosed circuit embodiments.

Certain exemplary embodiments comprise a pulse-generating circuit having multiple activation elements extending therefrom (for example, multiple flexible activation elements). The pulse-generating circuit and activation elements can be housed, for example, within a flexible, generally pad-shaped, outer housing that enables the activation elements to be placed proximate to the desired location in a comfortable and compact manner.

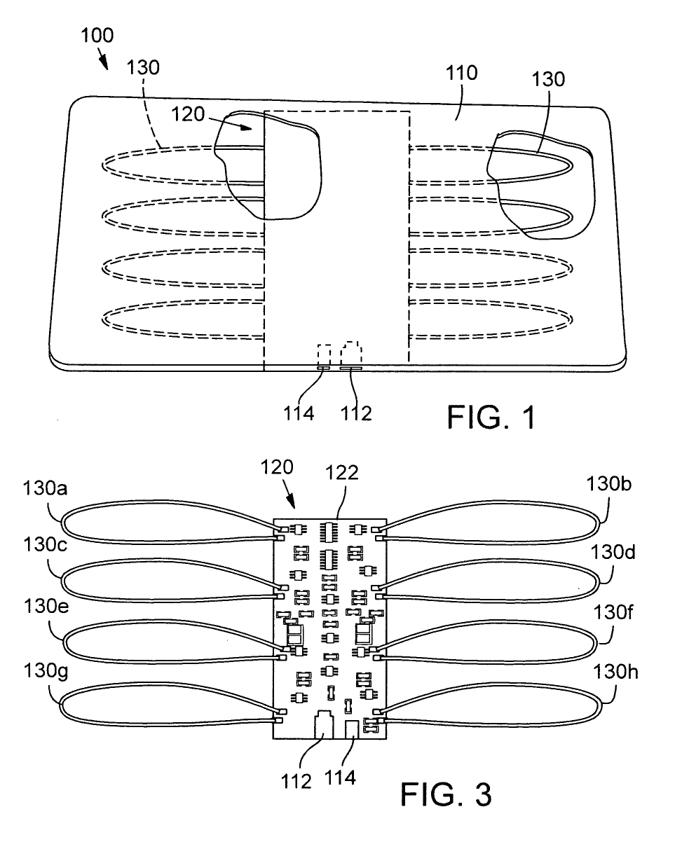

FIG. 1 is a perspective view showing an exemplary pulsed electromagnetic therapy system 100. The exemplary system 100 comprises a flexible housing 110 at least partially enclosing one or more pulse-generating circuits 120. In particular embodiment, the flexibility of the housing 110 allows an exterior surface of the housing to be conformable to a body part of a subject to be treated. The housing 110 can be formed from a variety of moldable and durable encapsulation materials that provide adequate protection of the internal circuitry. For example, in the illustrated embodiment, the housing 110 comprises a synthetic material (for example, latex, rubber, or silicone, such as RTV silicone) molded into a generally pad shape and configured to securely house the pulse-generating circuit 120 and the activation elements 130 within an interior defined by the housing, which can extend across a majority of the housing. For example, the housing 110 can be molded so that the pulse-generating circuit 120 and the activation elements 130 remain in their desired positions even when the housing 110 is moved, jostled, pressed, bent, or otherwise disturbed. In other embodiments, the housing 110 is made of a foam laminate. For example, the housing 110 can be formed from successive layers of foam that are cut out to form the desired enclosures for the pulse-generating circuit 120. In certain implementations, the foam is selected to be sufficiently rigid so that the system 100 is durable but comfortable. In embodiments in which the pulse-generating circuit is powered from an external source (for example, a standard 120V outlet), the housing can include a suitable aperture for a power cord. In embodiments in which the pulse-generating circuit is powered from an internal source (for example, a 9V battery), the housing may not include any apertures. In these embodiments, the housing can include a mechanism for accessing the battery (for example, a removable section of the housing).

In the embodiment illustrated in FIG. 1, the housing 110 encloses a single pulse-generating circuit 120 having a plurality of activation elements 130, though in other embodiments a plurality of pulse-generating circuits (each having a plurality of activation elements) can be enclosed within the housing 110. In the illustrated embodiment, the activation elements 130 extend away from the circuit board and conduct current pulses generated by the pulse-generating circuit 120. The time-varying magnetic fields produced during the rise and fall times of the current pulses can be used to induce electrical fields in the tissue of a subject against which an exterior surface of the housing 110 is placed. Because the strength of the magnetic field generated by a given activation element 130 decreases with the distance from the activation element 130, the housing 110 is desirably formed so that the activation elements 130 can be located adjacent or nearly adjacent to the treatment region of a subject during treatment (for example, at a distance of 2 cm or less). For example, in one exemplary embodiment, the thickness of the portion of the housing 110 between the activation element and the surface of a region to be treated is about 1 cm. Furthermore, in certain exemplary embodiments, the activation elements extend across at least a majority of the interior of the housing.

The shape, height, length, and width of the housing 110 will vary from implementation to implementation. For example, in certain implementations, the housing 110 has a height dimension, a length dimension, and a width dimension, where the width dimension is less than that of the height and length dimensions (for example, between at least 3 times less and at least 10 times less). In some embodiments, the width dimension of the housing is less than 3 inches, such as between 0.1 inches and 1 inch. Furthermore, although the shape, length, and width of the housing 110 will vary from implementation to implementation, in one particular embodiment the housing 110 is about 25 cm long and 10 cm wide. In other embodiments, the height and width dimensions are much larger, such that the housing forms a blanket-like housing. In these embodiments, multiple pulse-generating circuits can be disposed throughout the housing. In particular implementations, selected subsets of the pulse-generating circuits can be activated such that only a region of the blanket-shaped housing produces pulsed electromagnetic fields.

As noted, the shape and dimensions of the housing 110 generally vary depending on the intended treatment purpose of the system 100. The pad-shaped embodiment of FIG. 1, for example, can be placed against numerous surfaces of a subject to be treated, including surfaces that are not easily accessible. For example, the system 100 can be used to treat hard-to-reach regions of patients who are at least partially immobile. For instance, the system 100 can be slid underneath a body portion of a subject who is in a bed or between a body portion of a patient and her wheelchair (for example, adjacent to the lower back of the subject). Moreover, the flexible nature of the housing 110 allows an exterior surface of the system 100 to substantially conform to the surface against which it is placed (the region of the housing 110 in which the circuit 120 is located, however, is typically less flexible). Consequently, the activation elements 130 can be disposed at a desired distance from the treatment region. In the embodiment shown in FIG. 1, the housing 110 further includes an exposed portion wherein a power-adapter socket 112 for receiving the plug of a power-adapter cord and an indicator 114 (for example, an LED light) for indicating whether the pulse-generating circuit 120 is operating are located.

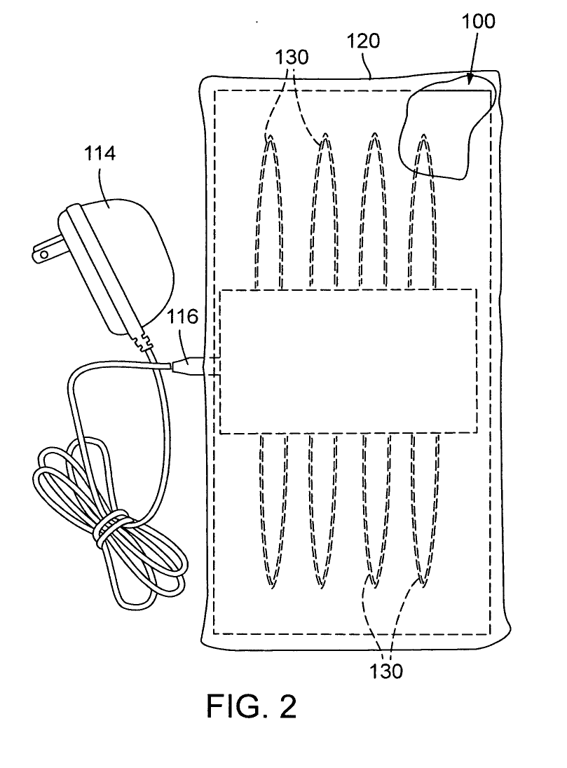

In FIG. 2, the housing 110 is shown covered by an external layer 111. For example, the external layer 111 can provide a desirable tactile feel to the system 100. The external layer 111 can also provide additional protection of the pulse-generating circuit 120 from external forces. In the illustrated embodiment, for instance, the external layer 111 comprises a rugged fabric, such as a heavy cloth. FIG. 2 also shows an external power cord 116 and power adapter 114 coupled to the pulse-generating circuit 120. For example, in the illustrated embodiment, the power adapter 114 comprises an AC/DC adapter to convert a 120 V AC source to a 9 V DC source. These values, however, should not be construed as limiting as other voltages and conversions can be performed depending on the available power supply and the configuration of the pulse-generating circuit 120. Further, in other embodiments, a battery is used to power the pulse-generating circuit 120 (for example, a 9 V battery).

FIG. 3 is a top view of an exemplary pulse-generating circuit 120 removed from the housing 110. The exemplary pulse-generating circuit 120 comprises surface-mounted components on a printed circuit board 122. As described above, however, the circuit 120 can be implemented using a variety of different fabrication technologies (for example, integrated circuit technologies). Eight activation elements 130a-130h extend from the pulse-generating circuit 120 and form eight loops through which current pulses are conducted and thereby generate time-varying magnetic fields used in treatment. The activation elements 130a-130h can comprise any suitable wire or conductive material. For example, in some embodiments, flexible stranded wire is used. The shape and size of the loops formed by the activation elements varies from implementation to implementation, but in one embodiment, the loops extend outwardly to a distance of about 10 cm. Furthermore, in some embodiments, the distance between one portion of a given loop (for example, the portion conducting current pulses outwardly from the pulse-generating circuit 120) and another portion of the loop (for example, the portion conducting current pulses inwardly towards the pulse-generating circuit 120) is desirably large enough so that the cancellation of magnetic fields resulting from loop portions having opposing current flows is reduced or substantially eliminated. For example, in certain embodiments, the distance between the outwardly conducting and inwardly conducting portions of a loop is 1 cm or greater for at least a portion of the loop. Because the inductance exhibited by a given activation element depends in part on its overall length and size, however, the activation elements can be further configured so that their overall lengths and sizes do not prevent the desired rise and fall times from being obtained. For example, in certain embodiments, the overall length and size of the activation elements is limited so that they exhibit self inductances that allow for rise and fall times of less than 100 nanoseconds, such as around 10 to 20 nanoseconds or as short as 1 to 2 nanoseconds. Thus, an activation element can be designed so that the distance between opposing currents is large enough to help reduce the cancellation of magnetic fields but also so that the overall length and size of the activation element is small enough to enable the desired rise and fall times. The shape and dimensions of the activation elements will vary from implementation to implementation and generally depend on the materials used to form the activation elements as well as the desired rise and fall times of the current pulses.

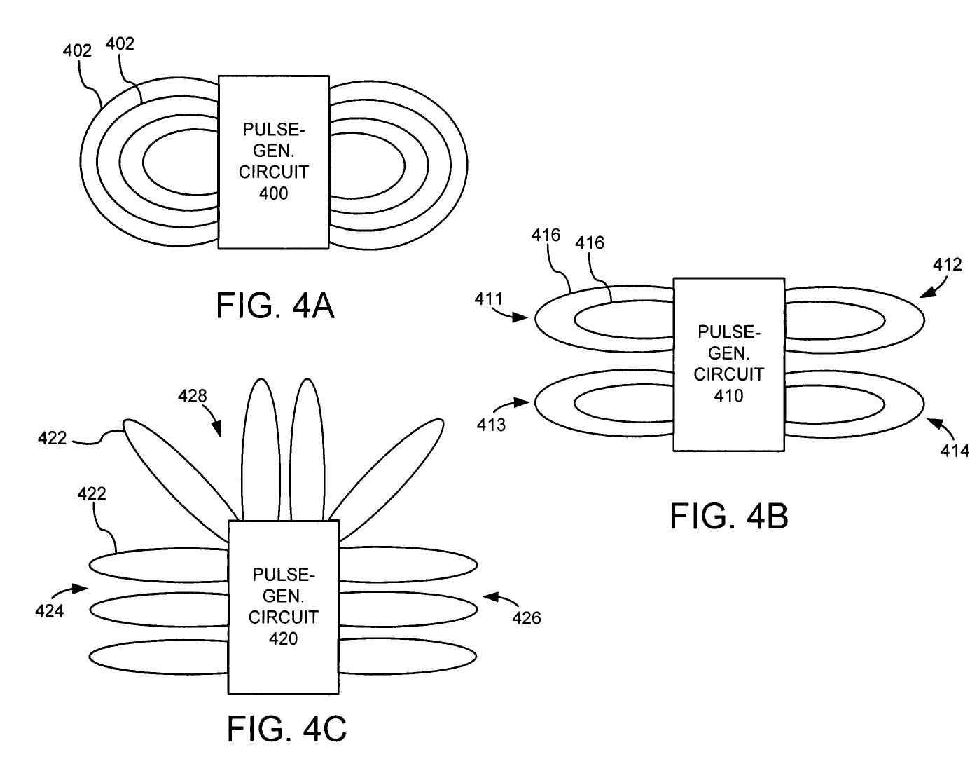

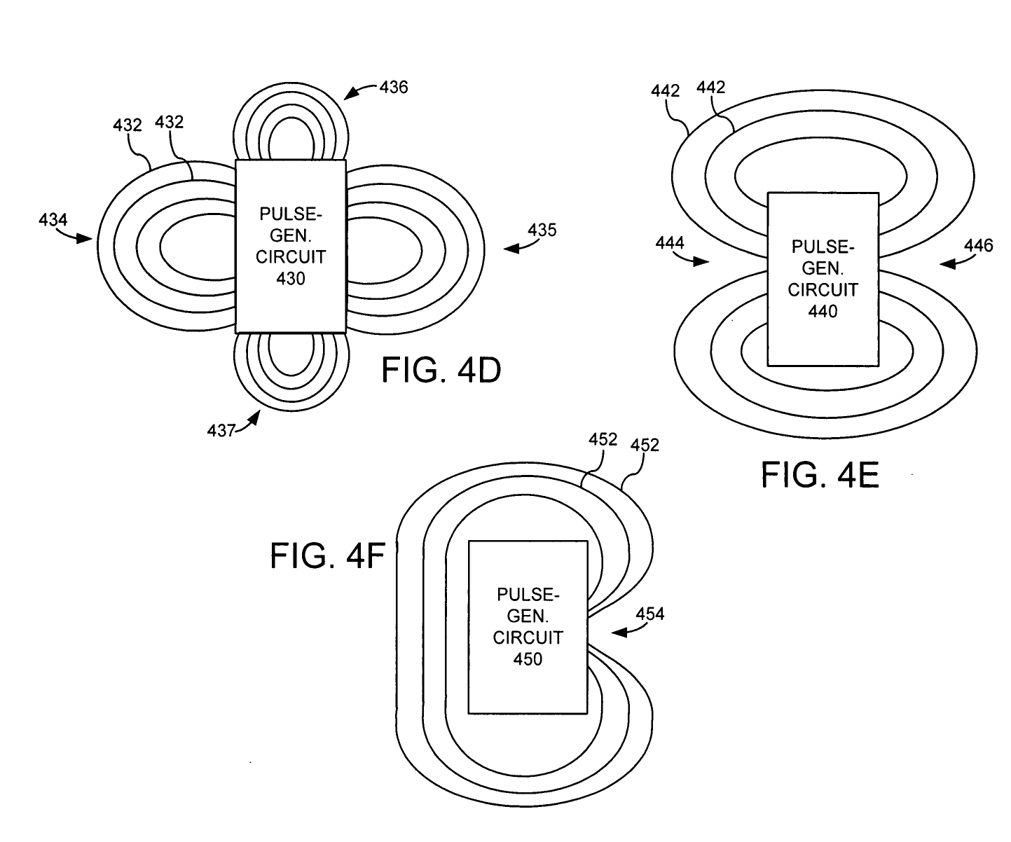

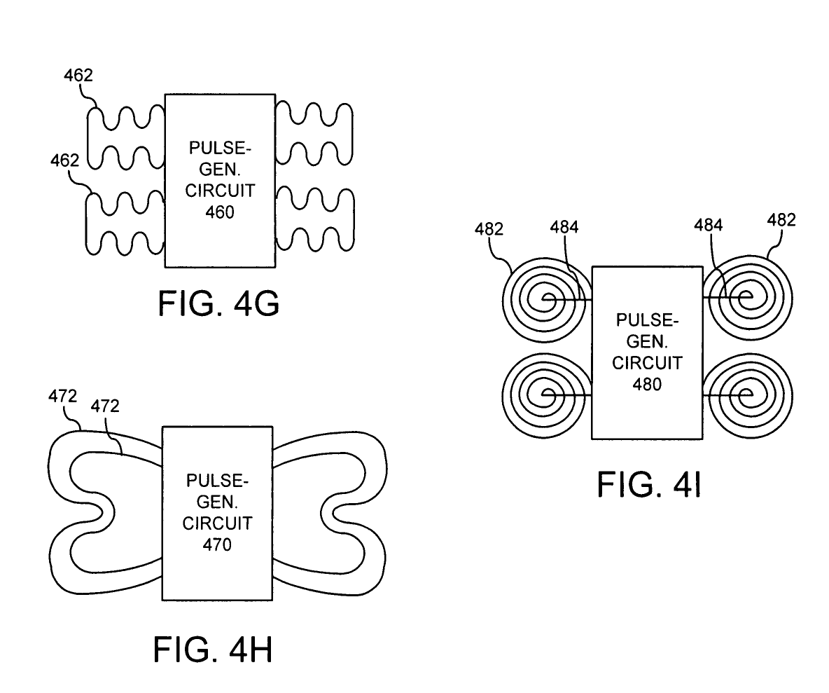

The particular number and configuration of activation elements illustrated in FIG. 3 should not be construed as limiting, as a wide variety of configurations using various numbers of activation elements (for example, two, three, four, and so on) can be used. For example, FIGS. 4A-4I show samples of different possible activation element configurations.

FIG. 4A shows an exemplary pulse-generating circuit 400 coupled to multiple activation elements 402 nested within each other. FIG. 4B shows an exemplary pulse-generating circuit 410 having four sections 411, 412, 413, 414 of multiple activation elements 416 nested within each other. The nested arrangement of the activation elements in FIGS. 4A and 4B can help, for example, reduce the possibility that the magnetic fields generated by the activation elements cancel each other out. Further, and as explained above, the activation elements of these embodiments (or any embodiment described herein) can be further configured so that their size or length does not create an inductance that prevents the desired rise and fall times from being obtained.

The activation elements of the disclosed embodiments do not necessarily extend only from the sides of the pulse-generating circuit but can extend in other directions from the pulse-generating circuit. For example, FIG. 4C shows a pulse-generating circuit 420 having multiple activation elements 422 extending from sides 424, 426 of the circuit as well as from a top 428 of the circuit. Similarly, FIG. 4D shows an exemplary pulse-generating circuit 430 having multiple sections of activation elements 432 nested within each other. For example, in FIG. 4D, side sections 434, 435 each have multiple nested activation elements 432, and top and bottom sections 436, 437, respectively, also have multiple nested activation elements 432. The activation elements can also have ends that are connected on different sides of the pulse-generating circuit. For example, as shown in FIG. 4E, pulse-generating circuit 440 comprises multiple nested activation elements 442 that originate at a first side 444 of the circuit 440 and terminate at a second side 446. Still further, the activation elements of the pulse-generating circuit can, in some embodiments, extend around the circuit. For example, FIG. 4F shows an exemplary pulse-generating circuit 450 comprising activation elements 452 that originate and terminate at a first side 454 of the circuit 450 but extend around the circuit 450.

The path of the activation elements extending from the pulse-generating circuit can also have a variety of different configurations. For example, the path followed by any of the activation elements described herein can include one or more serpentine regions. For example, in FIG. 4G, an exemplary pulse-generating circuit 460 comprises activation elements 462 that proceed in a generally serpentine fashion. The activation elements 462 are otherwise similar to those shown in FIG. 3. FIG. 4H shows an exemplary pulse-generating circuit 470 showing multiple activation elements 472 nested within each other, wherein one or more of the activation elements 472 include serpentine regions.

Further, in FIG. 4I, an exemplary pulse-generating circuit 480 has multiple activation elements 482 that are disposed in an at least partially spiral path. In such embodiments, the distance between portions of the spiral pathway can be selected so that the mutual inductances between the path portions do not prevent the current pulses from having the desired rise and fall times. In FIG. 4I, the portions 484 of the activation elements 482 that extend between the center of the spirals and the respective sides of the pulse-generating circuit 480 are at substantially right angles with the portions of the spiral pathway they traverse. Accordingly, the portions 484 do not substantially interfere with the magnetic fields produced in the spiral pathways.

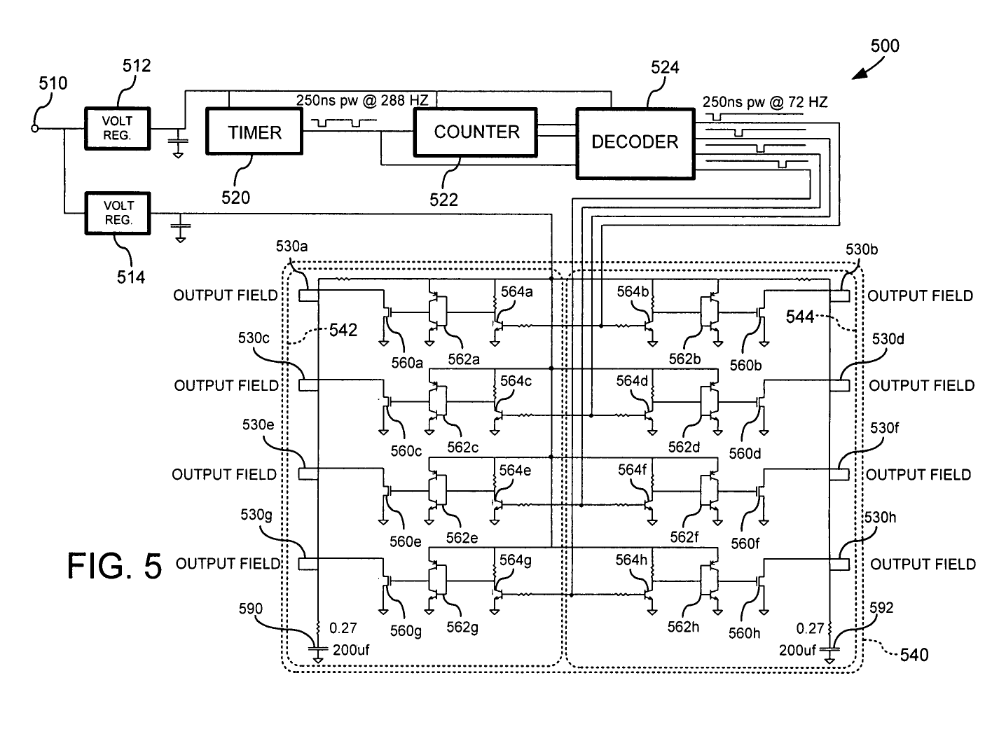

As more fully explained below with respect to the exemplary circuit shown in FIG. 5, the activation elements of FIGS. 4A and 4B (or any embodiment described herein) can be pulsed sequentially. For example, the activation elements can be pulsed individually or in various combinations of two or more activation elements. According to one exemplary embodiment, the activation elements are pulsed so that two immediately adjacent activation elements are not pulsed at the same time. By pulsing the activation elements in a sequence, mutual inductance effects between adjacent or nearby activation elements can be reduced or substantially eliminated. The current pulses through the activation elements can consequently have faster rise and fall times.

The current pulses conducted by the activation elements of any of the disclosed embodiments can vary from implementation to implementation. In certain desirable embodiments, however, the current pulses have fast rise and fall times (for example, less than 100 nanoseconds). In particular embodiments, the rise or fall time is less than 100 nanoseconds, such as around 10 or 20 nanoseconds, and in some embodiments is less than 5 nanoseconds, such as around 1 or 2 nanoseconds. Furthermore, in certain embodiments, the pulse width is relatively short. For example, in particular embodiments, the pulse width is less than about 1 microsecond (for example, at or substantially at 250 nanoseconds). In other embodiments, however, the pulse width is longer (for example, on the order of microseconds, such as between 1 and 999 microseconds) but can still have the desirably fast rise and fall times (for example, less than 100 nanoseconds). Still further, the pulse frequency in certain embodiments is between 10 to 100 Hz (for example, at or substantially at 70 Hz). In order to generate such fast rise and fall times, the pulse-generating circuitry as well as the activation elements can be designed to operate with little inductance. For instance, the pulse-generating circuit can be designed to operate highly efficiently with little or no mutual inductance and with self inductances that are small enough to enable the fast rise and fall times. Furthermore, in certain embodiments, the magnetic field generated by the activation elements is less than about 3 gauss, and in particular embodiments is 2 gauss or less at a distance of 1 cm from the activation elements. Because it is not necessary to generate high strength fields in these embodiments, circuit components that produce such fields but that also create undesirable inductances (such as coils and other intentional inductors) can be minimized or eliminated entirely from the design.

An exemplary circuit 500 for generating current pulses in any of the embodiments described herein is illustrated by the circuit diagram shown in FIG. 5 and described below. The exemplary circuit 500 corresponds to the pulse-generating circuit 120 of FIGS. 1 through 3 and drives eight activation elements. The circuit 500 can be readily adapted by one of ordinary skill in the art to drive any other number of activation element disposed according to other activation-element configurations, including those shown and described above with respect to FIGS. 4A-I.

Referring now to FIG. 5, DC power is received at a power source node 510. For example, the DC power can be 9 V DC from an AC/DC adapter (as shown in FIG. 2) or from a 9 V battery. A first voltage regulator 512 is configured to provide power to the logic elements of the circuit. For example, the first voltage regulator 512 can be a 5 V voltage regulator. In the illustrated embodiment, the logic elements include a timer 520, a counter 522, and a decoder 524. The timer 520 is configured to produce a pulse having a desired pulse width and frequency. For example, the timer 520 can be configured to produce a pulse having a pulse width of 1 microsecond or less (in one specific embodiment, at or substantially at 250 nanoseconds). As more fully explained below, the frequency of the pulse generated by the timer 520 will depend on whether the activation elements are to be activated sequentially during two or more different times. For example, in the illustrated embodiment, four sets of two activation elements each are pulsed during four different respective time frames. Thus, the timer 520 generates a pulse having a frequency that is four times the desired pulse frequency of each activation element. For example, in the embodiment illustrated in FIG. 5, the desired pulse frequency is 72 Hz. Consequently, the timer is configured to generate a pulse having a frequency of 288 Hz (as shown by the exemplary waveform output from the timer 520 in FIG. 5). Any suitable timer can be used for the timer 520, but in one exemplary embodiment the timer 520 is a CMOS 555 Timer (from National Semiconductor) set in astable multivibrator mode. Although the timer 520 can produce a desirably fast-switching waveform, it cannot directly produce currents large enough to produce the desired magnetic fields. Accordingly, the waveform produced by the timer 520 is used to control the switching of transistors configured to produce current pulses of the desired amplitude (for example, for magnetic fields of about 2 gauss, the current pulses are about 15-20 amps). The pulse stream output from the timer 520 is input into a counter 522 and a decoder 524, which are configured to produce multiple non-overlapping output waveforms having the desired pulsewidth and timed to produce the desired frequency. For example in the illustrated embodiment, the counter 522 is a 2-bit counter and the decoder 524 is a 2-to-4 decoder enabled by the output waveform from the timer 520 and receiving the output of the counter 522. As illustrated by the example waveforms output from the decoder 524 in FIG. 5, the four resulting waveforms produce a sequence of four pulses at a frequency of 72 Hz. It should be understood that the particular arrangement illustrated in FIG. 5 and described above should not be construed as limiting in any way, as multiple other circuit configurations (comprising different logic and circuit components, for example) can be used to produce the desired waveforms. All such alternative arrangements known to those of ordinary skill in the art are considered to be within the scope of this disclosure.

The waveforms output from the decoder 524 can be used to sequentially trigger separate sets of activation elements 530, thus allowing the circuit 500 to produce the desired magnetic fields (for example, 2 gauss) at the desired frequency (for example, 70 Hz) using a relatively small power source (for example, a 9 V DC source). In the illustrated embodiment, the activation elements are divided into four sets of two elements each. In particular, the first set consists of activation elements 530a and 530b (corresponding to activation elements 130a and 130b of FIG. 3), the second set consists of activation elements 530c and 530d (corresponding to activation elements 130c and 130d), the third set consists of activation elements 530e and 530f (corresponding to activation elements 130e and 130f), and the fourth set consists of activation elements 530g and 530h (corresponding to activation elements 130g and 130h). Furthermore, in the illustrated embodiment, the circuitry used to drive the activation elements 530a-h can be generally termed a field generator array 540 and can be divided into a first field generator section 542 corresponding to the activation elements on one side of the circuit 500 (for example, activation elements 530a, 530c, 530e, and 530g) and a second field generator section 544 corresponding to the activation elements on the other side of the circuit (for example, activation elements 530b, 530d, 530f, and 530h).

A second voltage regulator 514 is coupled to the power source node 510 and is configured to provide power to the field generator array 540. In the illustrated embodiment, the second voltage regulator 514 produces an 8 V output. The voltage regulator 514 provides a voltage to respective terminals of transistors 560a-h 562a-h, and 564a-h. In the illustrated embodiment, the transistors 560a-h comprise n-channel field effect transistors (NFETs). Furthermore, the voltage regulator 514 charges a first capacitor 590 and a second capacitor 592, which are respectively associated with the field generator array sections 542 and 544. In the illustrated embodiment, the capacitors 590, 592 comprise 200 microfarad capacitors. The capacitors 590, 592 are coupled to 0.27 Ohm limiting resistors, which are used to limit the current to the desired amount (for example, 15-20 amps) during discharge. In certain embodiments, such as the embodiment illustrated in FIG. 5, the capacitors 590, 592 are shared by two or more of the activation elements 530, thus reducing the overall size and cost of the circuit 500. In the illustrated example, the sequential activation of the sets of activation elements allows the capacitors 590, 592 to be shared among the sets of activation elements by reducing the peak current required during current pulsing. For example, in the embodiment illustrated in FIG. 5, a single 200 microfarad capacitor provides the desired current for a set of four activation elements (elements 530a, 530c, 530e, and 530g or elements 530b, 530d, 530f, and 530h). By contrast, if the four respective activation elements of a set were pulsed simultaneously, four 200 microfarad capacitors or their equivalent (for example, a single 800 microfarad capacitor) could be used to obtain the desired current pulses. Further, and as discussed above, the simultaneous pulsing of activation elements (for example, the simultaneous pulsing of adjacent activation elements) could increase the mutual inductance between the elements and thereby degrade the circuit performance.

In the illustrated embodiment, the transistors 560a-h are switched by respective push-pull drivers 562a-h coupled to respective saturated switching transistors 564a-h. In the illustrated embodiment, the push-pull drivers 562a-h comprise respective pairs of PNP and NPN bipolar junction transistors having bases controlled by the saturated switching transistors 564a-h. The transistors 564a-h of the illustrated embodiment comprise bipolar junction transistors whose bases are controlled by the waveforms output from the decoder 524 and whose collectors are coupled to the second voltage regulator 514 so that the transistors 564a-h operate in the saturation region. The saturated switching transistors 564a-h are used to accommodate the change to 8 V. The particular switching arrangement shown in FIG. 5 should not be construed as limiting, however, as alternative arrangements that similarly provide fast switching (on the order of 100 nanoseconds or less) can be used. For example, in some embodiments, the push-pull drivers are omitted or substituted with other types of drivers. Further, the particular type of transistor shown and described should not be construed as limiting, as various other transistor technologies (as described above) can be used depending on the implementation.

In operation, the sets of activation elements are activated sequentially by the waveforms produced by the decoder 524. In the illustrated embodiment, the first set is fired first, then the second set, and so on. In other embodiments, however, the sequence can vary. For example, the sequence can be: first set, fourth set, second set, and third set. Further, the particular activation elements associated with a set can vary from implementation to implementation. For instance, and with reference to FIG. 5, the first set of activation elements may comprise activation elements 530a and 530h, the second set may comprise activation elements 530c and 530f, and so on. Further, the activation elements can be pulsed one at a time, or in variable numbers. In still other embodiments, the activation elements are not pulsed in a sequential fashion, but are pulsed simultaneously. In such embodiments, the circuit 500 can be adapted to have multiple additional capacitors or larger capacitors than described above.

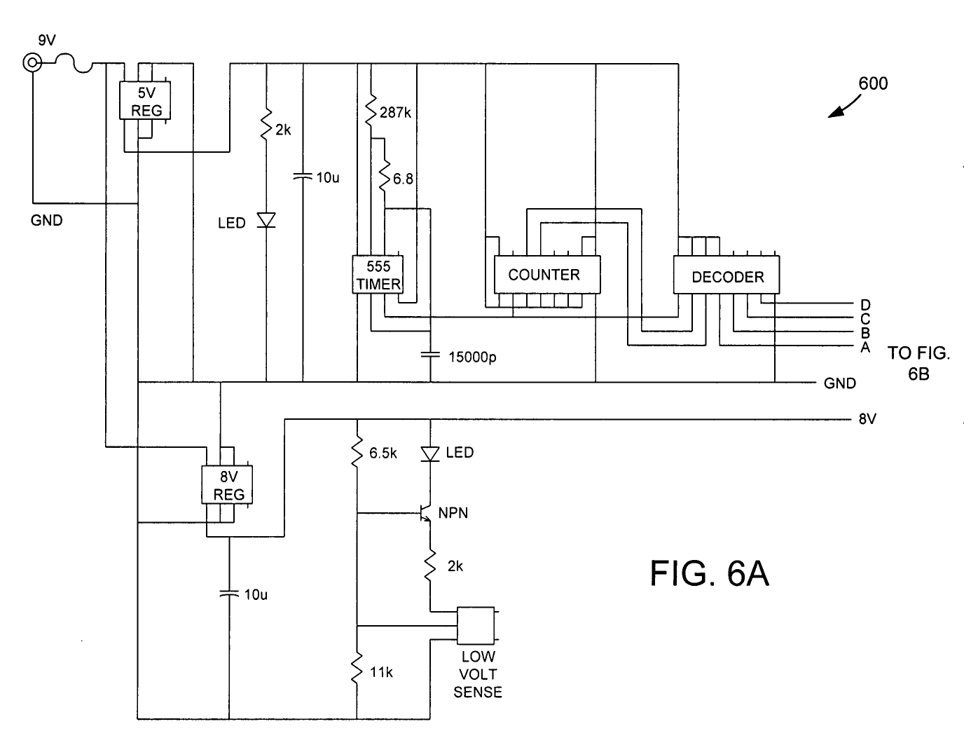

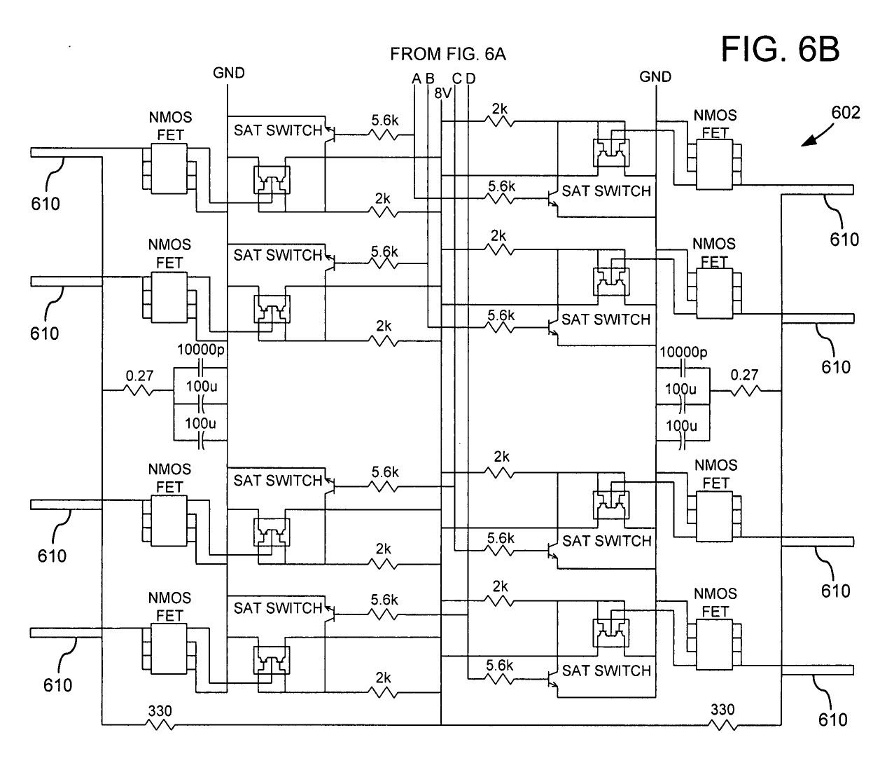

FIGS. 6A and 6B are circuit diagrams of another circuit embodiment for generating current pulses according to the disclosed technology. In particular, circuit portion 600 of FIG. 6A and circuit portion 602 form an alternative embodiment of the circuit 500 shown in FIG. 5. As with the exemplary circuit 500, the circuit portions 600, 602 drive eight activation elements 610. The circuit portion 600 is more particularly designed for operation with a 9V battery and further includes additional circuitry for sensing low voltage from the power supply. Exemplary values of the various electrical components are also shown in the circuit diagrams of FIGS. 6A and 6B. Furthermore, the NFETs in FIG. 6B are illustrated as being in a flat package. Any of the various components described above with respect to FIG. 5 can be used in the exemplary circuit portions 600, 602.

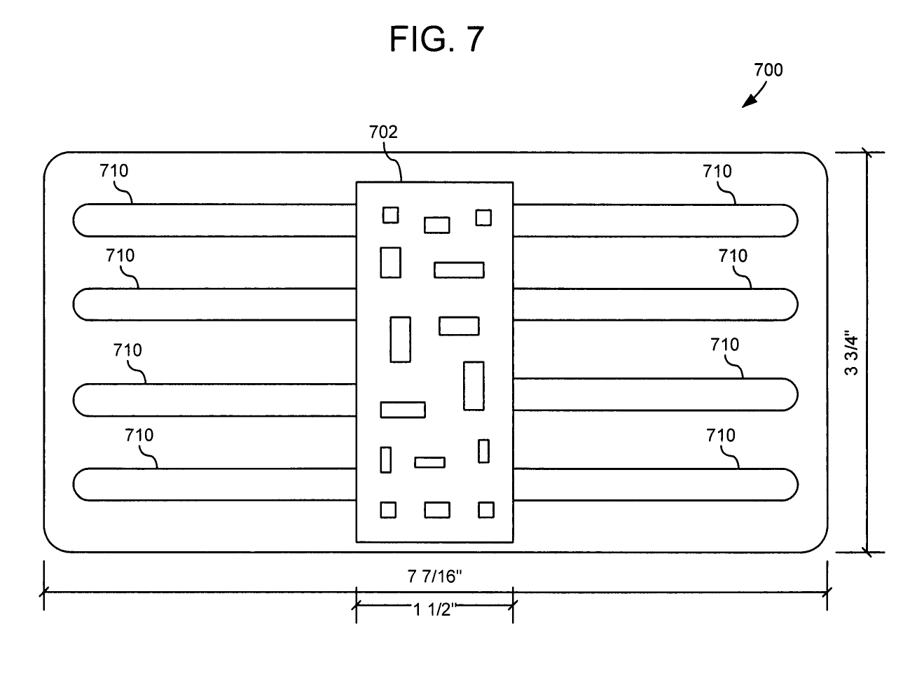

FIG. 7 is a schematic top view of an exemplary embodiment 700 of a pulse-generating circuit (the component board 702 along with the activation elements 710 extending therefrom) together with a housing. FIG. 7 shows exemplary dimensions for the component board and the housing for one particular, non-limiting embodiment.

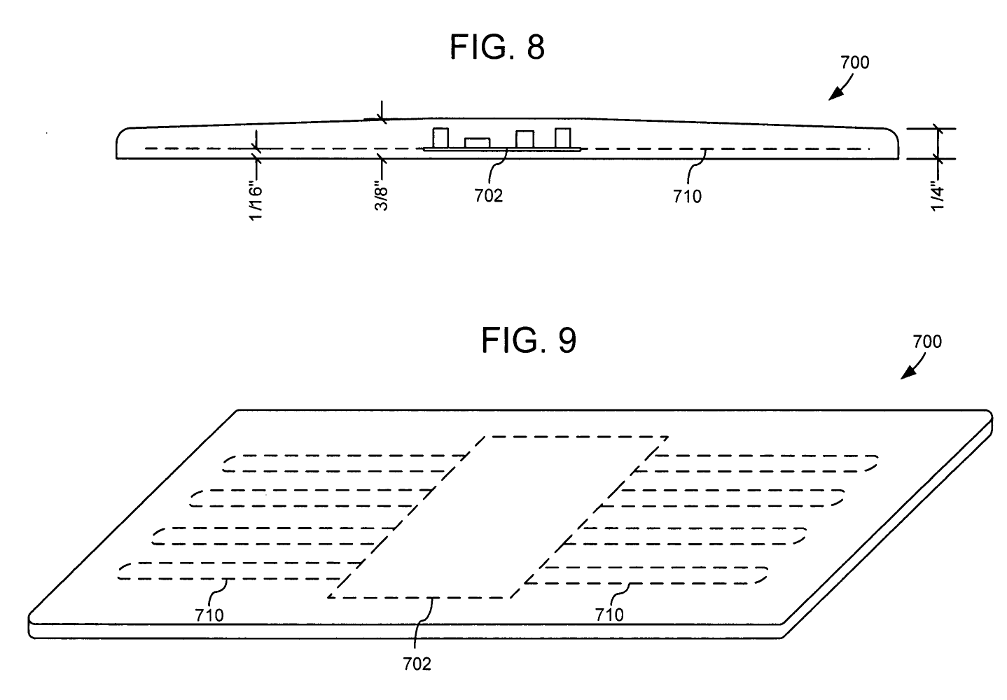

FIG. 8 is a schematic cross-sectional side view of the embodiment of FIG. 7. As with FIG. 7, FIG. 8 shows exemplary dimensions for aspects of the housing and the component board relative to the housing for one particular, non-limiting embodiment. FIG. 9 is a schematic perspective view of the embodiment of FIG. 7.

In some embodiments of the disclosed technology, at least a portion of the pulse-generating circuit or the activation elements are defined on one or more flexible substrates (for example, Mylar®, Teflon®, fiberglass, glass-reinforced Teflon®, or polyimide substrates). For example, the activation elements can be defined as conductive traces on the flexible substrate. For example, in certain embodiments of the disclosed technology, the activation elements are implemented as striplines formed on a flexible substrate. In certain embodiments, the striplines are implemented in a flexible, metal-clad dielectric substrate (for example, a copper-clad dielectric substrate). For example, a glass-reinforced Teflon® or fiberglass material can used (for example, having a thickness of about 0.032 inches) with one or more copper-clad sides (for example, 2 oz copper having a thickness of about 0.0028 inches). In certain exemplary implementations, the striplines are configured to form a resonant structure (a resonator). The resonators can be impedance matched with the pulse-generating circuit to allow for a desirably efficient transfer of pulse energy to the resonators. Impedance matching also helps maintain pulse fidelity, thus preserving the broad harmonic spectrum of frequencies created by the fast rise times of the generated pulses.

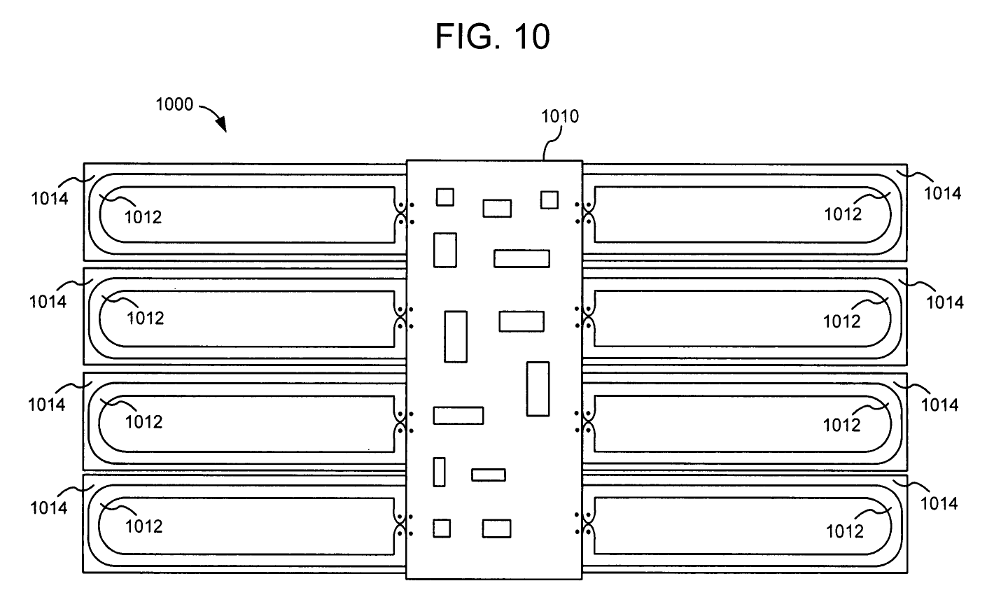

The stripline resonators can be formed through conventional photoetching techniques well known in the art. In particular embodiments, the stripline resonators are broadband RF loops, as shown for example in FIG. 10. The stripline resonators can have one end coupled to circuit ground and another end coupled to the transistor terminal producing the desired current pulses (as shown, for example, in FIGS. 5 and 6B). Furthermore, in some embodiments, the resonators are broad bandwidth RF loops and have a resonance in the microwave range.

The dimensions of the stripline resonators will vary from implementation to implementation. In one exemplary embodiment, one or more of the stripline resonators form a U-shaped conductive element with a length of about 4 inches and a width of about 0.5 inches. The individual line width of the stripline resonators will also vary (for example, depending on the desired performance characteristics of the pulse-generating circuit). In particular embodiments, the resonator line width is less than 0.3 inches (for example, about 0.1 inches).

FIG. 10 illustrates one exemplary embodiment of an electromagnetic therapy system 1000 having a pulse-generating circuit 1010 and multiple stripline resonators 1012. The pulse-generating circuit 1010 can be any of the pulse-generating circuits disclosed herein, and the pulse-generating circuit and stripline resonators can be housed in any of the housings disclosed herein. In the illustrated embodiment, the system 1000 comprises eight resonators 1012, which can be individually implemented on separate flexible substrates 1014. In other embodiments, two or more of the resonators are implemented on a common substrate. Furthermore, portions or all of the pulse-generating circuit 1010 can be implemented on a common substrate with the resonators. As noted, the overall size of the system 1000 will vary from implementation to implementation, but in one particular embodiment, the system 1000 has a height of 5 inches and a length of 10.5 inches, with each stripline resonator being implemented on a substrate having a height of 1.25 inches and a length of 4 inches.

In certain embodiments, the stripline resonators 1012 and the pulse-generating circuit 1010 are configured to provide pulses with rise or fall times of less than 100 nanoseconds, such as between 1 and 20 nanoseconds. In some desirable embodiments, the rise or fall time is between 4 to 15 nanoseconds. In certain embodiments, the pulse width is less than about 1 microsecond (for example, at or about 200 or 250 nanoseconds). In other embodiments, however, the pulse width is longer (for example, on the order of microseconds, such as between 1 and 999 microseconds). The pulse frequency can also vary from implementation to implementation. In certain embodiments, for example, the pulse width is between 1 to 100 Hz. The circuit voltage can similarly vary. For example, the circuit voltage can be between 5 to 9 V. The magnetic fields generated by embodiments of the pulse-generating circuit using stripline resonators are relatively small. For example, in certain embodiments, the magnetic field generated is less than about 3 gauss. In certain desirable embodiments, for instance, the magnetic field is between 1 and 2 gauss at the exterior surface of the housing (such as about 1.4 to 1.5 gauss).

Having illustrated and described the principles of the illustrated embodiments, it will be apparent to those skilled in the art that the embodiments can be modified in arrangement and detail without departing from such principles. For example, while embodiments of the disclosed technology were described above as having activation elements implemented as conductive traces on a flexible substrate, the activation elements can be defined as conductive traces on a less-flexible substrate (such as one or more PCB boards). The conductive elements can also be implemented as a variety of waveguide structures (for example, slotlines, coplanar striplines, coplanar waveguides, and the like). Furthermore, while certain embodiments of the activation elements were described as being resonant structures, any of the disclosed activation elements can be configured as low-resonance structures (for example, below a desired Q factor).

In view of the many possible embodiments, it will be recognized that the illustrated embodiments include only examples and should not be taken as a limitation on the scope of the invention. Rather, the invention is defined by the following claims and their equivalents. We therefore claim as the invention all such embodiments and equivalents that come within the scope of these claims.

What is claimed is:

1. An electromagnetic therapy system, comprising:
a pulse-generating circuit configured to create current pulses having rise or fall times of less than 100 nanoseconds;
two or more flexible activation elements coupled to the pulse-generating circuit and extending outwardly from and returning to the pulse-generating circuit, the activation elements being configured to conduct the current pulses and thereby generate time-varying magnetic fields; and
a flexible outer housing that encloses both the pulse-generating circuit and the activation elements, the housing being configured to define an exterior surface that is conformable to a region of a subject to be treated and that thereby positions the activation elements adjacent to the region of the subject to be treated.

2. The electromagnetic therapy system of claim 1, wherein the housing is a pad-shaped housing.

3. The electromagnetic therapy system of claim 1, wherein the housing has a width that is less than the height and the length of the housing.

4. The electromagnetic therapy system of claim 1, wherein the activation elements form single loops extending from the pulse-generating circuit.

5. The electromagnetic therapy system of claim 1, wherein the pulse-generating circuit further comprises timing circuitry that is configured to provide the current pulses to subsets of the activation elements according to a predetermined sequence, the subsets each comprising at least one of the activation elements.

6. The electromagnetic therapy system of claim 5, wherein the timing circuitry is further configured to provide current pulses to the subsets of the activation elements such that adjacent activation elements are not pulsed concurrently.

7. The electromagnetic therapy system of claim 1, wherein the activation elements are implemented as waveguide structures defined on a substrate.

8. The electromagnetic therapy system of claim 1, wherein the activation elements are striplines defined on a substrate.

9. The electromagnetic therapy system of claim 1, wherein the activation elements are stranded wires.

10. The electromagnetic therapy system of claim 1, wherein the pulse-generating circuit is configured to create current pulses having rise times of less than 20 nanoseconds.

11. The electromagnetic therapy system of claim 1, wherein the pulse-generating circuit is configured to create current pulses that generate magnetic fields of less than 3 gauss.

12. The electromagnetic therapy system of claim 1, wherein the pulse-generating circuit comprises:
a timer for generating a current-pulse waveform; and
one or more transistors coupled to the timer and configured to produce the current pulses delivered to the activation elements from the current-pulse waveform.

13. The electromagnetic therapy system of claim 1, wherein the pulse-generating circuit comprises one or more field generator sections, each field generator section corresponding to a respective subset of one or more of the activation elements and comprising transistors that generate the current pulses provided to the respective one or more activation elements in the subset.

14. The electromagnetic therapy system of claim 13, wherein the pulse-generating circuit further comprises one or more capacitors used in generating the current pulses, the one or more capacitors being shared between at least two of the field generator sections.

15. An electromagnetic therapy system, comprising:
a flexible housing defining an internal compartment and an exterior surface that is conformable to a body part of a subject, the flexible housing having a height, a length, and a width, the width being less than the height and the length; and
a circuit housed within the internal compartment of the flexible housing, the circuit including a plurality of conductive elements disposed across at least a majority of the interior compartment, the circuit and the conductive elements being configured to generate time-varying magnetic fields that extend out of the exterior surface of the flexible housing when the circuit is activated.

16. The electromagnetic therapy system of claim 15, wherein the conductive elements are U-shaped elements extending from the circuit.

17. The electromagnetic therapy system of claim 15, wherein the conductive elements form singular loops extending from the circuit.

18. The electromagnetic therapy system of claim 15, wherein the width is at least 3 times less than the height and the length.

19. The electromagnetic therapy system of claim 15, wherein the width is at least 10 times less than the height and the length.

20. The electromagnetic therapy system of claim 15, wherein the circuit generates current pulses having rise or fall times less than 100 nanoseconds.

21. The electromagnetic therapy system of claim 15, wherein the circuit generates current pulses having rise or fall times less than 20 nanoseconds.

22. The electromagnetic therapy system of claim 15, wherein the width of the flexible housing is less then 3 inches.

23. The electromagnetic therapy system of claim 15, wherein the plurality of conductive elements include striplines defined on a flexible substrate.

24. The electromagnetic therapy system of claim 15, wherein the plurality of conductive elements includes stranded wires.

25. An electromagnetic therapy system, comprising:
a flexible housing defining an interior;
a pulse-generating circuit located at least partially within the interior of the flexible housing; and
two or more conductive elements forming single loops operatively coupled to the pulse-generating circuit and located within the interior of the flexible housing,
the pulse-generating circuit including timing circuitry configured to generate current pulses in subsets of the conductive elements according to a sequence, the subsets of the conductive elements respectively comprising one or more of the conductive elements.

26. The electromagnetic therapy system of claim 25, wherein the timing circuitry is configured such that current pulses are not generated concurrently in adjacent conductive elements.

27. The electromagnetic therapy system of claim 25, wherein the two or more conductive elements extend across a majority of the interior of the housing.

28. The electromagnetic therapy system of claim 25, wherein a common set of one or more capacitors are used when the current pulses in the subsets of the conductive elements are activated.

29. The electromagnetic therapy system of claim 25, wherein the pulse-generating circuit is configured to produce current pulses of 100 nanoseconds or less in the conductive elements.

30. The electromagnetic therapy system of claim 25, wherein the flexible housing is a pad-shaped housing with a height dimension, a length dimension, and a width dimension, the width dimension being less than the height dimension and the length dimension by a factor of at least 3.

31. The electromagnetic therapy system of claim 25, wherein the flexible housing has a width that is less than 3 inches.

32. A method of performing electromagnetic therapy, comprising:
placing a conformable surface of an electromagnetic therapy system adjacent to a region of the subject that is to be treated; and
operating the electromagnetic therapy system such that current pulses having rise or fall times of less than 100 nanoseconds are sequentially provided to multiple activation elements disposed in the electromagnetic therapy system and positioned in proximity to the conformable surface, the multiple activation elements extending from a pulse-generating circuit in the electromagnetic therapy system.

33. The method of claim 32 performed to treat tissue trauma, the method further comprising identifying that the region of the subject that is to be treated is suffering from tissue trauma.

34. The method of claim 32 performed to treat inflammation resulting from tissue trauma, the method further comprising identifying that the region of the subject that is to be treated is suffering from inflammation resulting from tissue trauma.

35. The method of claim 32 performed to treat a free-radical-mediated condition, the method further comprising identifying that the region of the subject that is to be treated is suffering from a free-radical-mediated condition.

36. The method of claim 32 performed to treat osteoporosis, the method further comprising identifying that the region of the subject that is to be treated is suffering from osteoporosis.

37. The method of claim 32 performed to treat osteopenia, the method further comprising identifying that the region of the subject that is to be treated is suffering from osteopenia.

38. The method of claim 32 performed to treat an ischemia-perfusion injury, the method further comprising identifying that the region of the subject that is to be treated is suffering from an ischemia-perfusion injury.
